(19) United States
(12) Patent Application Publication
(10) Pub. No.: US 2021/0021473 A1
(43) Pub. Date: Jan. 21, 2021

(54) SYSTEMS AND METHODS FOR A DYNAMIC RATIO ADJUSTING GEARBOX FOR TRANSCEIVERS

(71) Applicant: Hewlett Packard Enterprise Development LP, Houston, TX (US)

(72) Inventors: KEVIN B. LEIGH, Houston, TX (US); MICHAEL WITKOWSKI, Houston, TX (US)

(21) Appl. No.: 16/513,003

(22) Filed: Jul. 16, 2019

(51) Int. Cl. H04L 12/24

(52) U.S. Cl. CPC H04L 41/0896

(57) ABSTRACT

Methods and systems support a dynamic ratio adjusting gearbox (DRAG) for communicating signals between at least one switch and a plurality of servers. The DRAG includes server interface ports, each coupled to a respective server. Each server interface port corresponds to a provisioned bandwidth, or the peak bandwidth allocated to the server interface port. The DRAG includes a switch interface port, coupled to a respective switch. The switch interface port corresponds to a provided bandwidth, which is the peak amount of bandwidth supported by the switch. The DRAG can dynamically allocate an amount of provisioned bandwidth for each server interface port such that an aggregate amount of provisioned bandwidth does not exceed an aggregate amount of bandwidth from the at least one switch coupled to the DRAG, and based on an amount of bandwidth utilized in operation, thereby improving bandwidth utilization and mitigating stranded bandwidth.

### DESCRIPTION OF RELATED ART

As demands for network services increase, the use of high-density switches are becoming increasingly more widespread in many networking applications. In a real-world example, high-density switches can be used in large scale enterprise data centers, where large amounts of data is often transferred between the network devices at high rates. High-density switches can be implemented as “top-of-rack” switches, for example in the case of enterprise data centers, which are typically connected to multiple servers. It may be desirable to connect a high-density switch to the multiple servers that it services, so as to reduce the number of layers (e.g., intermediary switches and other devices) that must be passed through for transferring data.

Also, in many cases, due to the larger bandwidth capacity of the high-density switches, the number of servers that can be serviced by a single high-density switch has increased. However, mismatches between the higher downlink bandwidth capabilities of a high-density switch and the lower bandwidth capabilities of the servers can lead to unused resources. Wasted resources, such as underutilized link bandwidth, may cause the network systems to be less than optimal. Therefore, gearboxes are being used to adapt the server connections to high-density switches in a manner that can make better use of the high-density switches full capabilities.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example of a switching system including a dynamic ratio adjusting gearbox (DRAG), according to some embodiments.

FIG. 2A depicts an example of the switching system in FIG. 1 including a gearbox having an integrated DRAG controller implementing various ratio adjustments, according to some embodiments.

FIG. 2B depicts another example of the switching system in FIG. 1 including a gearbox having an integrated DRAG controller implementing various ratio adjustments, according to some embodiments.

FIG. 2C depicts yet another example of the switching system in FIG. 1 including a gearbox having an integrated DRAG controller implementing various ratio adjustments, according to some embodiments.

FIG. 2D depicts yet another example of the switching system in FIG. 1 including a gearbox having an integrated DRAG controller implementing various ratio adjustments, according to some embodiments.

FIG. 3 depicts an example of a switching system including a gearbox connected to, and configured by, an external DRAG extension controller, according to some embodiments.

FIG. 4 depicts an example of the switching system including the DRAG, illustrating buffers and a data path flow through the system, according to some embodiments.

The figures are not exhaustive and do not limit the present disclosure to the precise form disclosed.

### DETAILED DESCRIPTION

Various embodiments described herein are directed to methods and systems using transceivers that include a dynamic ratio adjusting gearbox (DRAG). According to the embodiments, the DRAG has the capability to dynamically adjust an amount of bandwidth that is provided to servers, on a per-server basis (up to a bandwidth limit), in a manner that can improve utilization of the link and reduce stranded bandwidth. The hardware architecture of a conventional switch can include ports that provide a downlink (DL) connection to servers or other services (e.g., storage, computes). On the other hand, servers can include ports that allow for uplink (UL) connections to the switch.

In order to provide connections between the switch-side ports and the server-side ports, many conventional switches can facilitate direct connections, for instance by employing breakout cable assemblies, such as copper-based cable assemblies. For example, each cable can be connected between a single high-bandwidth switch port and a plurality of lower-bandwidth server ports. A commonly used breakout cable assembly is capable of transferring up to four (4) ten gigabit (10 G) signals using the widely known Ethernet protocol. Nonetheless, generally speaking, direct connections, via cable assemblies for instance, are limited due to physical connection constraints (e.g., only 4 connections, each at 10 G). Furthermore, cable connections may require the same data rate be available at both the switch-side port and the server-side port. However, several advancements in switch design have been trending towards progress in the port capabilities to support a steadily increasingly amount of bandwidth. In contrast, port capabilities at the server-end are not experiencing the same upward trend to keep pace with the improving bandwidth capabilities at the switch. That is, in many cases, servers may be restricted in the amount of bandwidth that is supported at their ports, having substantially lower bandwidth capabilities in comparison to the specifications of the switch. As a result, use of direct cable connections from the switch are becoming less practical, as there are many scenarios in which the data rate supported by the ports at the switch is not the same as (e.g., substantially higher) the data rate supported by the ports at the server.

As an example, ports at a switch, which was limited to lower bandwidth capabilities, such a one gigabit (1 G), have experienced growth over time to ten gigabits (10 G) and twenty five gigabits (25 G), and now can commonly provide 50 G per lane where each lane consists of a transmit channel and a receive channel. Additionally, each of the multiple ports of the switch typically provide the same data rate. For instance, in most implementations, a traditional switch does not include ports that are dedicated for lower bandwidth, such as 10 G ports, and then additional ports that can be used at the higher data rates, such as 25 G. Thus, the switch's ports can be characterized as having a relatively static framework (e.g., each port, providing the same fixed data rate), that is, in many practical real-world environments, inconsistent with operations at the server-end. At the server-end, the amount of bandwidth that may be needed by each server serviced by the switch can vary dynamically. In an example, there may be a server connected to the switch that requires only 5 G of bandwidth based on the particular applications that the server performs, while there are other servers connected to the same switch that require 9 G and 25 G respectively. As illustrated by this example, some existing switch-server connections can experience a mismatch between the amount of bandwidth provided by the ports of the switch (as each switch port is set to 25 G) and the amount of bandwidth required, and ultimately utilized, by the servers. One or more of servers may use substantially less bandwidth than made available by the switch, particularly in the above example by the servers that require comparatively little bandwidth (e.g., 5 G and 9 G). Therefore, available bandwidth that ultimately goes unused at the servers (hereinafter referred to as stranded bandwidth) is a problem that may be experienced in some datacenters. Even further, it may be expected for these problem associated with stranded bandwidth to grow in future datacenter environment (e.g., higher data rates at the switch). If the bandwidth capabilities of switch-end ports continues to advance, it may be difficult for servers to consume 50 G, for example, made available via a port at the switch, in most applications.

Despite challenges related to stranded bandwidth, it may still be effective, with respect to cost, to furnish a datacenter with switches that employ higher-bandwidth ports, such as 25 G, and allowing any servers that may have high bandwidth demands to be properly supported (e.g., comparable costs between switch using 10 G and 25 G ports). Due to the common use of higher-bandwidth ports at the switch-side, the divide between the amount of bandwidth provided by the switch and the amount of bandwidth utilization at the servers may widen, and the occurrences of mismatches increased.

Additionally, switches can be restricted by the number of physical ports available at the switch. For example, once a port at the switch is used to connect to a cable, and further providing a connection to a single server, that port is then completely occupied (e.g., 1-to-1 connection between switch port and server port). In other words, no additional servers can be connected to the switch via that same port. Accordingly, in scenarios when there is low bandwidth utilization at multiple servers that are occupying the already limited ports on the switch-side, the drawbacks associated with stranded bandwidth and wasted resources are often exacerbated. Moreover, in environments where there are more servers than number of ports (e.g., DL) at a single switch, then multiple switches will need to be deployed using the direct connection arrangement. Generally, switches can be expensive network elements. To this end, using a connection arrangement which impacts the number of switches needed (e.g., increasing the number of switches), also drives up costs of the architecture requiring additional network cables and network administrators. In an effort to address the abovementioned concerns and limitations, the disclosed embodiments employ a DRAG in a manner that can optimize bandwidth utilized, thereby mitigating negative impacts of stranded bandwidth and reducing overall implementation costs.

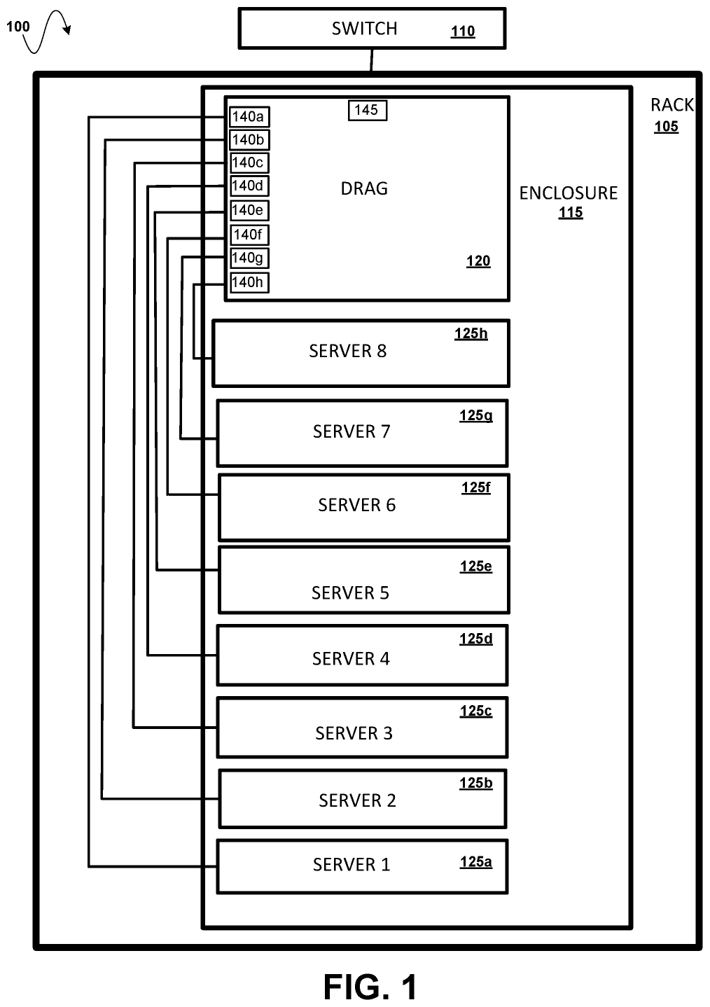

Now referring to FIG. 1, the system includes a switching system 100. As seen in FIG. 1, a rack 105 can be used to house multiple components therein. In the illustrated example, the rack 105 includes: a switch 110; a dynamic ratio adjustment gearbox (DRAG) 120; and multiple servers 125a-125h. Also, the DRAG 120, and servers 125a-125h are shown to be enclosed within an enclosure 115. In the example configuration of FIG. 1, the DRAG 120 can be an intermediate device that is situated in between the switch 110 and the servers 125a-125h, with respect to the data path. Multiple servers 125a-125h can be connected to respective server interface ports 140a-140h (also referred to herein as server-side ports) of the DRAG 120 to support the downlink of data to each of the servers, while the DRAG 120 uses at least one switch interface port 145 (also referred to herein as a server-side ports) in order to connect to the switch 110. It should be appreciated that variations of the ports shown in FIG. 1 can be implemented in some embodiments. For instance, multiple links (or lanes) may be connected from a switch interface port 145 to the switch 110. Additionally, the DRAG 120 can include multiple switch interface ports, although the example in FIG. 1 shows a single port 145. Moreover, the switch interface port 145 may be integrated within the DRAG 120 to facilitate electrical links to the switch 110 or optical links to the switch 110. In another embodiment, the switch interface port 145 may be implemented separate from the DRAG, for instance using an electrical retimer chip, or an electrical/optical transceiver chip.

As referred to herein, the DRAG 120 can be a link layer and/or physical layer device that implements the functionality associated with many traditional transceiver gearboxes, in addition to the features disclosed herein. For example, the DRAG 120 can be a device that combines or divides one or more network packets for further distribution. The switch 110 can be implemented as any one of the various forms of switches that can be used in network communications, such as an optical switch, optical transceiver, digital data switch and the like. In the illustrated example of FIG. 1, switch 110 can be an electrical switch (i.e., electrical signals are switched) with optical interfaces converting between electrical and optical, for instance when optical signals are used for longer distances (e.g., for high data rate network signals). In general, the switch 110 is configured to combine digital signals to generate a combined downlink signal, which it transmits to the DRAG 120. The DRAG 120 is configured to receive this combined downlink signal from the switch 120, and divide the combined downlink signal into its respective downlink components. The DRAG 120 then transmits each downlink component to the particular one of servers 125a-125h which is the intended destination for downlink. Unlike existing gear boxes where server ports always have lower bandwidth capability than a switch port, DRAG allows each of the server ports to have as high a bandwidth capability as the switch port, so that only one server can fully utilize the entire bandwidth of the switch port.

As seen in FIG. 1, there are multiple servers 125a-125h that are being serviced by the single switch 110. Therefore, the DRAG 120 can facilitate connections between the switch 110 using one lane, and the several connected servers 125a-125h using a number of lanes, in a manner that allows the number of lanes to switch 110 to be generally less than the number of lanes to servers 125a-125h. For instance, a lane from switch interface port 145 to the switch 110 can support a higher bandwidth than the bandwidth supported by each individual DL lane from server interface ports 140a-140h. In general, the DRAG 120 operates in a manner that ensures that an aggregate bandwidth of all of the lanes provided to servers 125a-125h via server interface ports 140a-140h, in operation, does not exceed the bandwidth of the lane to the switch 110 via switch interface port 145. As an example, the lane from switch interface port 145 can support 100 G. The DRAG 120 can initially evenly divide the bandwidth allocated for each lane to the servers 125a-125h using server interface ports 140a-140h based on the bandwidth available at the switch 110. Referring back to the example where the lane to switch 110 supports 100 G, the DRAG 120 can allow each of the eight lanes from server interface ports 140-140h to utilize 12.5 G of bandwidth.

In particular, the DRAG 120 can support functionality that allows an aggregation of the maximum bandwidth for each of the ports 140a-140h for DL to be greater than the aggregation of the bandwidth for the switch interface port 145. For example, the DRAG 120 is configured to dynamically adjust the amount of bandwidth that is made available for each of the servers 125a-125h via their respective 140a-140h port. In order to support the disclosed dynamic bandwidth allocation functions, the DRAG 120 has various capabilities that are related to facilitating transmission between the switch 110 and servers 125a-125h. For example, the DRAG 120 is configured to perform a handshake with any servers connected thereto, for example servers 125a-125h. As a result of the handshake, the DRAG 120 is aware of the bandwidth needed by the servers its services, and thus can dynamically adjust allocations across the servers. Additionally, the handshake can involve the DRAG 120 communicating to each server, the amount of bandwidth that is has been dynamically allocated. Also, the DRAG 120 has the capability to perform a negotiation with the switch 110, in order to prevent the switch 110 from transmitting at a data rate that exceeds the maximum bandwidth available to any destined server from servers 125a-125h via its respective port 140a-140h on the DRAG.

In contrast, an existing gearbox may only perform a data rate translation, for example in a downlink communication from the switch 110 to servers 125a-125h. However, there may be cases where another server connect to a switch 110 may need an amount of bandwidth that is greater than an equally-divided fixed amount of bandwidth that would be allocated to it by a traditional gearbox. The DRAG 120 disclosed herein has enhanced capabilities as compared to many currently used gearboxes, as it can dynamically re-allocate the bandwidth provided via its server interface ports 140a-140h to the multiple servers 125a-125h, in order to provide a portion of unused bandwidth that may have previously allocated to another server to increase the allocation for the server needing more bandwidth.

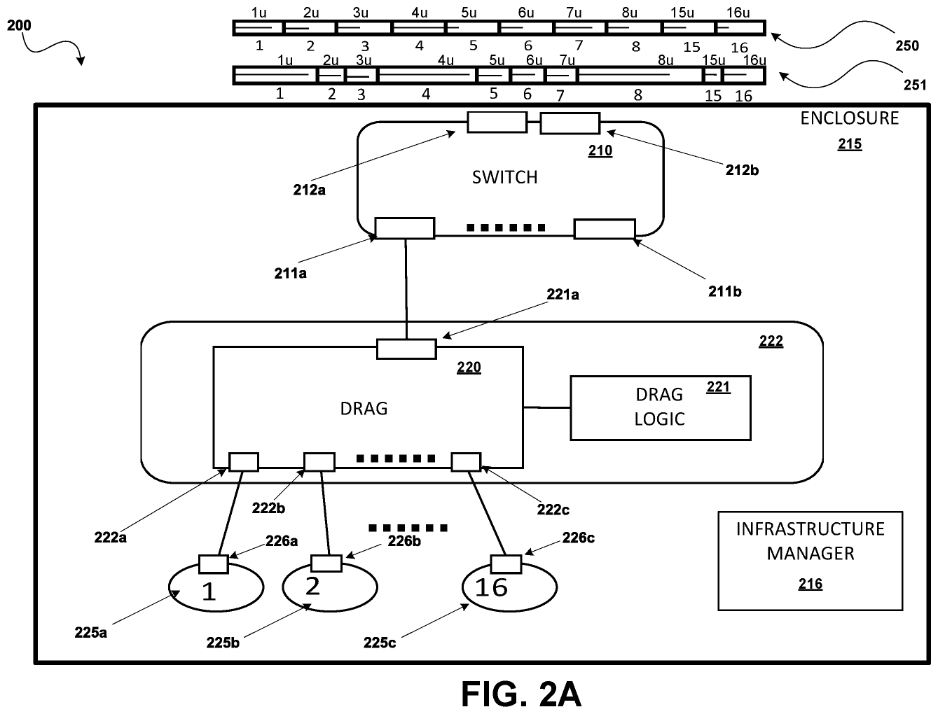

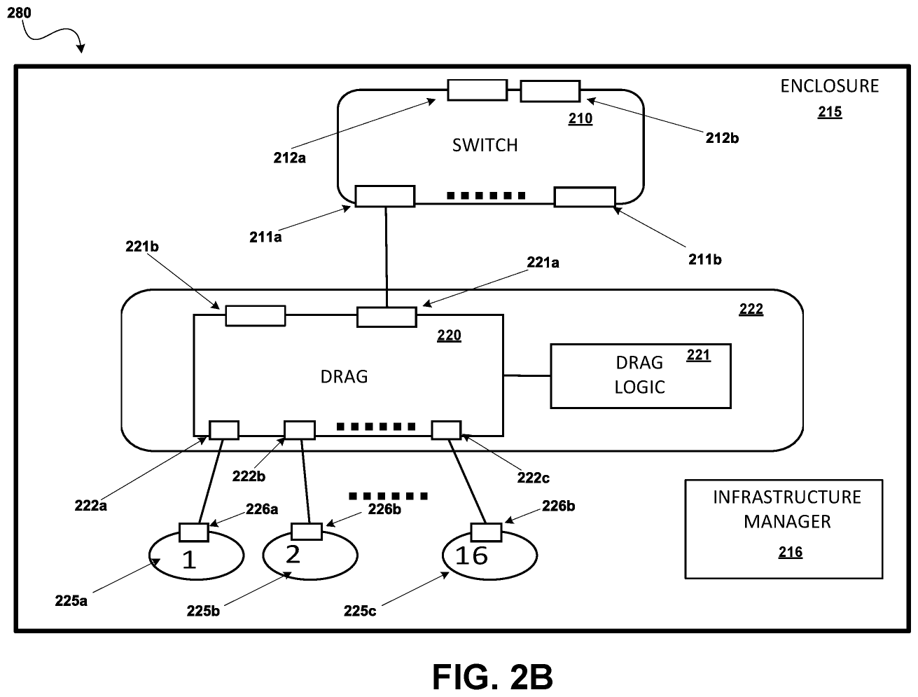

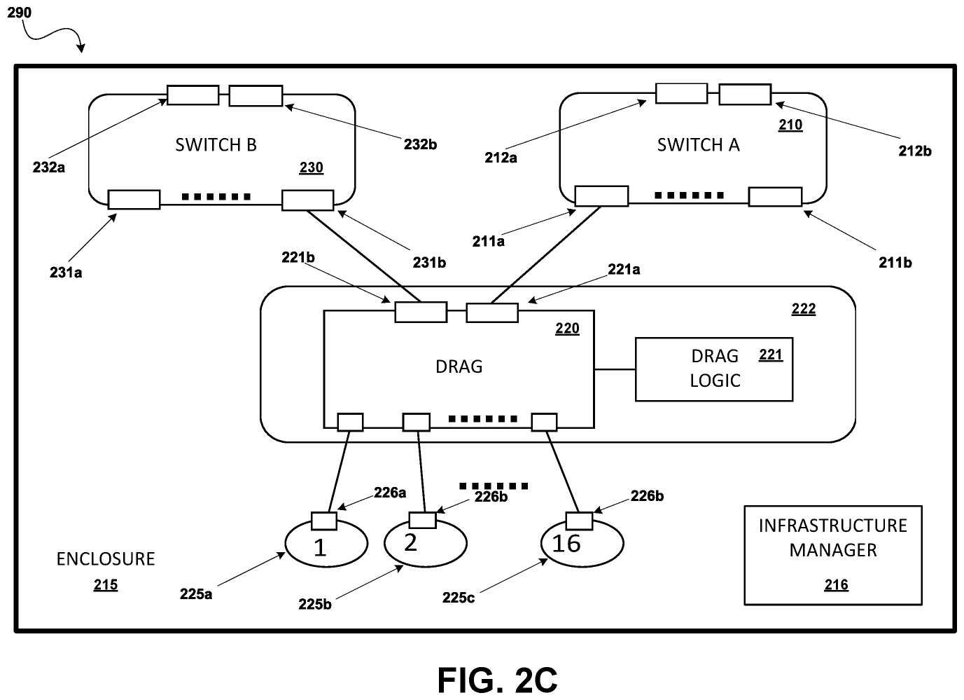

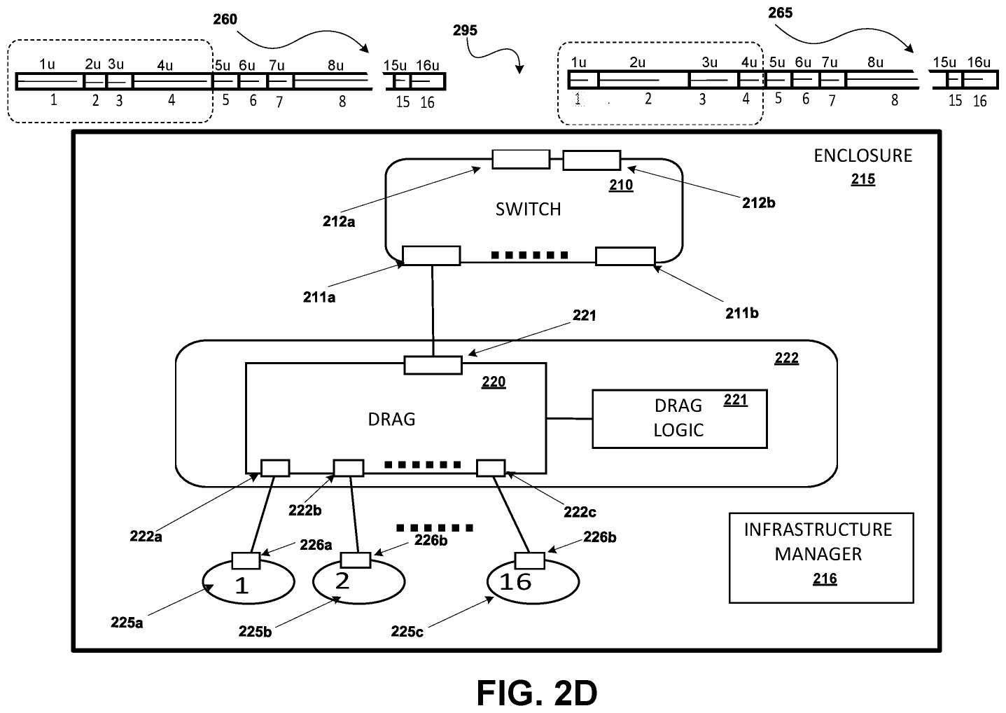

Again, referring to the previous example, a server 125a may only need 2 G of bandwidth during operation (which is less than the “evenly-divided” bandwidth allocation), while another server 125b may need 60 G for its applications (which is higher than the “evenly-divided” bandwidth allocation). With this knowledge, the DRAG 120 can adjust the amount of bandwidth allocation to servers 125a and 125b from the initial (evenly-divided) allocation, based on the dynamic demand per-server. That is, the DRAG 120 can reduce the bandwidth provided to server 125a via server interface port 140a from its initial allocation, using a portion of the difference, or unused bandwidth (e.g., 48 G), to supplement the additional bandwidth requested by server 125b, thereby increasing the bandwidth allocation for server 125b from 50 G to 60G, for example. In the example scenario, a traditional gearbox would be restricted to providing server 125a 50 G, despite the substantial amount of stranded bandwidth. Furthermore, a traditional gearbox would be limited to only allowing the server 125b to use the evenly-divided bandwidth of 50 G, which may impact the performance of the server 125b. The DRAG 120 can optimize bandwidth allocation as deemed appropriate for the particular operational environment, rather than being restricted solely by the fixed bandwidth allocations governed by device specifications (e.g., existing gearboxes). Additional examples of scenarios involving the dynamic bandwidth adjustment functions of the DRAG 120 are discussed in greater detail with reference to FIGS. 2A-2D below.

Referring now to FIG. 2A, an example of a switching system 200, including a DRAG 220 which implements dynamic ratio adjustment in an example scenario is shown. In the illustrated example, system 200 with multiple elements housed within enclosure 215. As seen, the enclosure 215 can include: a switch 210; DRAG box 222 including a portion implementing the interfaces (referred to as the DRAG) and a portion implementing a DRAG logic 221, that can be for controlling the interfaces; servers 225a-225c (representing 16 servers); and infrastructure manager 216. In some instances, the infrastructure manager 216 may be configured to manage multiple enclosures, for example in an architecture where the switch 210 and the DRAG box 222 may be located in different enclosures from each other. The switch 210 has ports 211a, 211b for downlink towards the servers 225a-225c, and ports 212a, 212b for uplink. DRAG 220, as illustrated, includes a port 221a that can be considered switch-side, and multiple ports 222a-222c that can be considered server-side. Although the switch 210 is configured with multiple ports, the DRAG 220 can be connected to switch 210 using only one of its available ports, shown as port 211a at switch 210 having connecting lane to port 221a, which is switch-side at the DRAG 220. Furthermore, the servers 225a-225c are shown to each have a respective uplink port 226a-226c. The DRAG 220 can be connected to each of the multiple servers 225a-225c, illustrated as connections between each port 226a-226c at each server 225a-226 and a complimentary port from ports 222a-222c at the DRAG 220. In particular, a lane is formed between DRAG 220 and server 225a by connecting port 226a at the sever 225a to port 222a at the DRAG 220. A second lane is formed between DRAG 220 and server 225b by connecting port 226b at the sever 225b to port 222b at the DRAG 220, and so on in a similar manner for additional servers (e.g., servers 3-15 not shown). Lastly, a sixteenth lane is formed between the DRAG 220 and server 225c by connecting port 226c at the sever 225c to port 222c at the DRAG 220.

In the example scenario of FIG. 2A, the switch 210 may be configured to support a bandwidth of 200 G via the lane to the DRAG 220 at port 221a. Then, as alluded to above, the DRAG logic 221 may be configured to perform an initial allocation of bandwidth for each of the servers 225a-225c, where the bandwidth that is initially allocated to each server is an aggregated maximum bandwidth supported by the all of the switch lanes, evenly-divided by the total number of connected servers. Accordingly, the aggregate bandwidth provided by switch 210 in this scenario is 200 G, which will be evenly-divided between each of the sixteen servers, shown as servers 225a-225c, connected to the DRAG 220, thereby initially allocating 12.5 G of bandwidth for each of the servers 225a-225c.

As previously described, the DRAG has the capability to determine the aggregate bandwidth that is supported by the switch 210 from all of its connected ports, which is port 211a in this case. Additionally, at some time after the initial allocation, the DRAG logic 221 can perform a handshake (also referred to as negotiation) with the servers 225a-225c in order to determine a peak bandwidth demand (e.g., the bandwidth requested by a server or the operation bandwidth used by the bandwidth of a server port). This query can be performed as part of a negotiation between the DRAG logic 221 and the servers 225a-225c, which may be performed periodically (e.g., a preset time period). Thus, the DRAG logic 221 has a dynamic awareness of the particular bandwidth requirements for each server, detecting when the bandwidth demand varies per server. Furthermore, the DRAG logic 221 can determine a peak bandwidth to be allocated to each of the server ports 226a-226c (which is also referred to herein as the provisioned bandwidth). Due to the DRAG logic 221 being aware of the bandwidth that is provided from the switch port 221a, and the particular bandwidth needs by each server 225a-225c, the DRAG logic 221 can evaluate the bandwidth utilization across the servers 225a-225c. Restated, the DRAG logic 221 can dynamically determine whether the initially allocated bandwidth for each server 225a-225c is being efficiently utilized (e.g., during a current time period), i.e. any of the servers' bandwidth demand are significantly under-utilizing or over-utilizing bandwidth relative to the bandwidth allocated to those severs. As a result of the determination, the DRAG logic 221 can then perform a dynamic adjustment of the bandwidth that is allocated via each of the server ports 226a-226c. For instance, the DRAG logic 221 can adjust the allocated peak bandwidth to be higher or lower than the initially evenly-divided bandwidth allocation of 12.5 G. In a scenario where server 225a communicates to the DRAG logic 221 that its operation requires more bandwidth than an amount initially allocation, for example 25 G, then the DRAG logic can dynamically modify the bandwidth allocations across the servers 225a-225c to accommodate the increased demand at server 225a. In this case, the DRAG logic would find server ports (e.g. servers 225b-225c) that are under-utilizing their allocated bandwidth, reduce their allocations, and add the freed bandwidth to the server 225a.

A representation of dynamically adjusted bandwidth allocations that may be determined by the DRAG logic for each of the 16 server 225a-225c, during a time segment, is illustrated as bar graphs 250 and 251. The bar graphs 250 and 251 illustrate multiple bar segments 1-16, where each of the 16 segments correspond to a respective bandwidth allocation for each of the 16 servers 225a-225c. In particular, bar segment “1” represents the bandwidth allocation for server “1” 225a, and bar segment “2” represents the bandwidth allocation for server “2” 225b, and so on until bar segment 16 representing the bandwidth allocation for server “16” 225c.

As seen, the multiple bar segments of bar graphs 250 and 251 have a length that approximately represents the amount of bandwidth that the DRAG logic 221 has allocated to the corresponding server 225a-225c, during that time segment. The bar graphs 250 and 251 represent the previously described scenario, where the DRAG logic 221 initially allocates each of the servers 225a-225c the same amount of bandwidth (e.g., 12.5 G), which is the amount of the available bandwidth provided by the switch 210, 200 G in the example, evenly divided between 16 servers 225a-225c. Accordingly, each of the bar segments in bar graph 250 have equal lengths, representing the evenly-divided amount of bandwidth that the DRAG logic 221 has initially allocated to the corresponding server 225a-225c in a first time segment. Furthermore, the bar graphs 250 and 251 include a line segment (line inside of each bar segment) that represents that amount of bandwidth utilized by each respective server. Similar to the bar segments, line segment “1u” represents the bandwidth utilization for server “1” 225a, and line segment “2u” represents the bandwidth utilization for server “2” 225b, and so on until line segment “16u” representing the bandwidth utilization for server “16” 225c. Bar graph 250 particularly illustrates that although each of the servers 225a-225c are initially allocated the same amount of bandwidth (represented by the bar segment) that the amount of bandwidth that is actually utilized by each of the servers 225a-225c varies. As an example, the bandwidth that is being utilized by server 225b illustrated by line segment “2u” is substantially less than its initial bandwidth allocation illustrated by bar segment “2”. In another time segment, represented by bar graph 251, the DRAG logic 221 has dynamically adjusted the bandwidth per server, depending on a determined utilization at each of the servers 225a-225c.

Referring now to bar graph 251, the graph 251 represents that the DRAG logic 221 has dynamically increased the bandwidth given to some servers from their initial allocation, shown by some bar segments having lengths that have been increased (with respect to the bar graph 250). In particular, bar graph 251 shows that DRAG logic 221 has increased the bandwidth allocation for servers “1”, server “4” and server “8.” Additionally, bar graph 251 shows that the DRAG logic 221 has dynamically decreased the bandwidth allocations of some servers from their initial allocation, for example based on the DRAG logic 221 determining that a server has low bandwidth utilization (e.g., server bandwidth demand less than the evenly-divided bandwidth allocation). This is shown in bar graph 251 by some bar segments having shorter lengths (with respect to the bar graph 250). In bar graph 251, the bar segments corresponding to server “2”, server “3”, server “5”, server “6”, “server “7”, and server “15” and server “16” illustrate that DRAG logic 221 has decreased their respective bandwidth allocations to be less than the initial evenly-divided allocation. It should be appreciated that although the lengths of the individual bar segments in bar graph 251 have been adjusted, that the total length of the bar graph 251 (sum of each of the segments) is the same as the length of bar graph 250. This serves to illustrate that the DRAG logic adjusts the bandwidth allocation across the servers 225a-225c, while ensuring that the aggregated bandwidth allocations for all the servers 225a-225c does not exceed the available bandwidth provided by the switch 210 (represented by the total length of the bar graphs 250 and 251). Moreover, bar graph 251 illustrates the reduction of stranded bandwidth that may be realized by the DRAG 220. In comparison, the differences in lengths between the bar segments “1”-“16” and the respective line segments “1u”-“16u” has been greatly reduced in bar graph 251 (e.g., the line segment length is closer to the bar segment length). In other words, the DRAG logic 221 has dynamically adjusted the bandwidth allocated for each of the servers 225a-225c in bar graph 251, allowing there to be less allocated bandwidth that goes unused by the respective server (e.g., less difference between the line segment length and bar segment length). For instance, in bar graph 251, the line segment “2u” is approximately the same length as bar segment “2”. This illustrates that the amount of bandwidth that is actually utilized by server 225b, represented by line segment “2u” is closer to the amount of bandwidth that is allocated by the DRAG 220, illustrated by bar segment “2”.

FIG. 2A also serves to illustrate an example architecture according to an embodiment, where the DRAG box 222 is illustrated as including a DRAG logic 221 integrated therein. The DRAG logic 221 can be implemented as specialized hardware, circuitry, firmware, software or any combination thereof deemed capable of implementing the DRAG capabilities described. For instance, the DRAG logic 221 can be implemented using circuitry, such as an integrated chip (IC) circuit programmed to perform the DRAG capabilities as disclosed, such as an application-specific integrated circuit (ASIC). Accordingly, the DRAG logic 221 and the interfaces facilitating links to the switch 210 and servers 225a-225c (e.g., server-side ports 222a-222c and switch-side port 221a) can be provided in single device, or box, shown as DRAG box 220. In some embodiments, the DRAG logic 221 can be implemented as a microcontroller on a hardware module of the DRAG box 222.

FIG. 2A also serves to illustrate an example architecture according to an embodiment, where the DRAG box 222 is illustrated as including a DRAG logic 221, which can be implemented as specialized hardware and/or software that is integrated into a gearbox device, DRAG 220. In some embodiments, the DRAG logic 221 can be implemented as a microcontroller on a hardware module of the DRAG box 222.

Another aspect related to the capabilities of the DRAG disclosed herein, includes a bandwidth negotiation process that occurs between the switch 210, DRAG box 222, the servers 225a-225c, for example via the server's network interface cards (NICs), and the infrastructure manager 216. The infrastructure manager 216 can establish multiple management connections (direct or indirect) to the servers 225a-225c, for instance via the server's baseboard management controller (BMC), the switch 210, for instance via the switch's management central processing unit (CPU), and the DRAG box 222, for instance via a microcontroller implementing the DRAG logic 221. These aforementioned management connections can be implemented using various mechanisms, such as the Ethernet, CAN Bus, or other interconnect deemed capable for supporting two-way communication for the infrastructure manager 216. The management connections facilitated by the infrastructure manager 216 can be used for resource discovery, connectivity discovery (e.g., determining whether a server's ports 226a-226c, which may be implemented as NIC ports, are connected to the appropriate server-side ports 222a-22c for DL at the DRAG 220, and discovering which switch-side ports 221a at the DRAG 220 for UL are connected to which ports 211a-211b at the switch 210), and resource allocation control. In some cases, the servers 225a-225c, in particular the BMC, can have a separate communication channel for management control to the NIC (e.g., implemented as an out-of-band link). An in-band link can be described as through the connected data link between each server of the servers 225a-225c and DRAG 220, as well as switch 210 and DRAG 220. The severs 225a-225c (e.g., the BMC) can use this communication channel with the NIC to receive operational information, and to set control of various attributes, including the bandwidth controls. In other words, NICs of the servers 225a-225c can use their respective BMC as a proxy for communication to the infrastructure manager 216. These management connections can be generally described as “out-of-band” management paths, because the communication occurs over connections that are dedicated for management, and are not the primary data path through the system 200.

Alternatively, in some embodiments, there can be an “in-band” management communication. In contrast to the previously described out-of-band management, in-band management communicates the bandwidth control, and related information, over the primary data path of the system 200. For purposes of discussion, the primary data path of the 200 can be considered to include connections for DL between the server-side ports 222a-222c of the DRAG 220 and the ports 226a-226c of the servers (e.g., NIC ports), and connections for UL between the switch-side ports 211a of the DRAG 220 and the ports 211a-211b of the switch 210.

Accordingly, via the management connections, the infrastructure manager 216, the servers 225-225c, and the switch 210 can perform a negotiation to achieve optimal bandwidth allocation in order to optimize the utilization of bandwidth made available between the servers 225a-225c and the switch 210 via the DRAG box 222. It should be understood that the DRAG box 222 can have a higher aggregate bandwidth on the physical DL connections, than is available on the aggregate bandwidth of the UL connections. Therefore, the DRAG logic 221 is configured to enforce a restriction of the aggregate bandwidth allocation across all of the servers 225a-225c to ensure that the operation is below the physical bandwidth capabilities of the UL connections, so as to avoid data buffer overrun within the switch-side ports 221a. Over-subscribe, as used herein, describes when the aggregate bandwidth of the ingress traffic on the DL ports (226a-226c) of the DRAG 220 exceeds the aggregate bandwidth of the egress traffic of the associated UL ports (221a) to which the traffic from the DL ports will be forwarded to. When this over-subscription occurs for periods of time that cause the data buffer in the DRAG 220 to overflow, then data is lost. In the case that the utilization of the traffic on the DL ports (226a-226c) is below the maximum bandwidth, even though the maximum bandwidth of ingress traffic on the DL ports (221a) could over-subscribe the UL ports (226a-226c) of the DRAG 220, in actuality, utilized bandwidth of the ingress traffic to the DL (226a-226c) ports will be below the maximum bandwidth of the UL ports (221a) and thus data overrun will not occur. This applies to the bandwidth of the aggregate traffic being transmitted by the servers 225a-225c connected to the switch port 221a via the DRAG 220. Likewise, the switch 210 can be configured to restrict the bandwidth being transmitted from the port 211a, through the DRAG 220 to the ports 222a-222c in order to prevent sending bursts of data that will overrun a single DL connection beyond its maximum capability. Many traditional gearboxes, as alluded to above, utilize static configurations that cannot be adjusted, regardless of situations that may change during operation that may impact bandwidth consumption and allocation demands, such as changes in the network topology (e.g., servers powered down and not utilizing their allocated bandwidth), changes in the network traffic load, or demand requirements of the servers. Even further, some existing gearboxes insert idles within data streams to fill up the unused portion of the signal toggle rate equivalent to line bandwidth to maintain the fixed bandwidth.

Accordingly, the bandwidth negotiation that is facilitated via the management connections (e.g., in-band, or out-of-band), allow the system 200 to be initially configured with a reference, or initial configuration, which governs an amount of bandwidth that is initially allocated by DRAG logic 221. Then, the DRAG logic 221 can further perform bandwidth negotiation over the management communication connections to adjust the configuration at the servers 225-225c (e.g., NICs), the DRAG box 222, and the switch 210 in order to dynamically adapt to the network characteristics that similarly may change dynamically, such as network topologies and/or operating conditions (e.g., traffic load requirements).

The bandwidth negotiation process, involving the DRAG box 222 and its functionality as disclosed herein, can begin with an initialization by the infrastructure manager 216. The infrastructure manager 216 can initialize the servers 225a-225c, the DRAG box 222, and the switch 210 to deliver a default, or initially allocated, amount of bandwidth. As described above, this bandwidth is limited in manner that avoids oversubscribing the bandwidth through the DRAG box 222. For the servers 225a-225c (e.g., NICs), there may be an operating maximum bandwidth configured (in the NIC) that may be lower than the maximum physical link bandwidth capability of the ports 226a-226c and the link to the DRAG box 222. The NICs of each servers 226a-226c can be programmed to ensure that the operational maximum bandwidth is not exceeded, for example using internal rate limiters that are typically standard in NIC hardware. Each of the servers 225-225c connected to the DRAG box 222 can be configured in such a manner that the aggregate bandwidth of all of the ports 226a-226c (NIC ports) at the respective servers 225a-225c connected to the DRAG box 222 are less than the aggregate UL bandwidth of the DRAG ports 221a and UL connections to the switch 210.

At the switch 210, there may be an operational maximum bandwidth that is configured for the traffic transmitted by a switch port 221a to the server-side ports 222a-222c of the DRAG box 222, and then to particular port 226a-226c at one of the respective servers 225a-225c. In this case, there can be a series of rate limiters for the traffic being transmitted to the DL through the DRAG box 222, such that the switch 210 does not generate bandwidth to one of the server NICs through the DRAG box, than is greater than the physical maximum bandwidth of the ports 226a-226c and the corresponding links between the servers 225a-225c and the DRAG 222. The number of rate limiters on the port 211a at the switch 210 can be equal to the number of DL connections between the DRAG box 222 and the servers 225a-225c. For example, the switch 210 can determine which traffic is being sent to a particular DL from the DRAG box 222 to a NIC in one of the servers 225a-225c by tagging the packets for the traffic destined for that particular server with a special purpose tag header. The tag header may be inserted into a packet that represents a virtual switch interface, for example. The rate limiter can be applied to traffic destined through this virtual switch interface, and shaped appropriately. Then, a NIC at the destination server among the servers 225a-225c can strip the tag before the sending the packet to the server. Likewise, traffic sent from the servers 225a-225c, via its NIC, to the switch 210 can be tagged in a similar manner, so that the switch can identify media access control (MAC) addresses and internet protocol (IP) addresses that may belong to the virtual switch interface. In some cases, the virtual interface number of these address are stored in forwarding tables for traffic transmitted the servers 225a-225c.

At the DRAG box 222, the DRAG logic 221 can be programmed with the operating maximum bandwidths for all of the ports 226a-226c (NIC ports) at the servers 225a-225c that are connected thereto. This allows the DRAG box 220 to take packets received from the ports 226a-226c over the DL connections, and perform the appropriate time slicing of these packets onto the UL connections to the switch-side port 221a. Because the switch 210 is performing rate limiting of traffic over the UL to the DRAG box 222, the DRAG box 222 does not have to shape or restrict the traffic bandwidth towards the DL connections to servers 225a-225c.

After the initialization, there may be situations in the operational environment that may impact bandwidth allocations, such as dynamic changes to the topology that may lead to a sub-optimized configuration. For example, if servers 225a, which is initially connected to the DRAG box 222 at the time of initialization, is eventually powered down (or removed from the server bays), then there is no traffic requirement for the corresponding DL connection from port 222a on the DRAG for DL to the server 225a. Therefore, in this case, the NICs at servers 225b-225c that are active can be configured via management mechanisms to increase their operating maximum bandwidth, in order to maximize the aggregate traffic from the DL connections to the UL connections through the DRAG box 222. Similarly, in this case, the DRAG box 222 can be configured through management to the updated bandwidth values on the DL connections to match the configuration of the NICs at the respective servers 225b-225c on each DL. In referring back to example of server 225a being powered down (or removed), if the server 225a is later powered up (e.g., replaced in the sever bay), then management can configure the NICs of severs 225a-225c and the DRAG box 222 to the appropriate setting considering the change. It should be appreciated that these changes may not affect the configuration settings for the switch 210, as these are limits based on the maximum bandwidth of the physical DLs (e.g., not the maximum operating bandwidth).

Although the abovementioned negotiation process generally describes negotiating equal bandwidth for both transmit and receive directions, the disclosed system and techniques are not intended to be limited to this capability. In some embodiments, the dynamic bandwidth negotiation process can be independently applied to a communication with respect to the direction of the transfer of data. That is, in some embodiments, a negotiation can be performed specifically to configure the system 200 for receive (RX) communications to the switch 210 (e.g., data uplink from the servers 225a-225c). Then, another separate negotiation can be used particularly configuring the system 200 for transmit (TX) communications from the switch 210 (e.g., data download to the servers 225a-225c). The capability to independently apply a negotiation process to a communication based on either TX or RX direction may be desirable in some scenarios, for instance in the case of applications that may require different bandwidth needs for the server group connected to a DRAG. In addition, some applications (e.g., streaming servers, image processing, video/audio processing, Big Data search, etc.) may require the same data to be broadcasted by a switch port to all the servers via the DRAG, i.e., full line-rate for all servers' receive ports for some time period. In this scenario, the aggregate bandwidth of all of the server receive ports may conceptually exceed switch downlink bandwidth. However, this scenario is not an issue since using the disclosed DRAG negotiation techniques, as the same data is sent from a switch port to all server ports that are connected to the DRAG. The DRAG will have data replication from switch port to server ports. Servers' transmit ports still need to be regulated to not exceed switch port receive bandwidth.

The bandwidth negotiation aspects described above also require particular functionality to be implemented at the servers 225a-225c connected to the DRAG box 222 in order for the dynamic bandwidth adjustment approach to be achieved. A server, such as server 225a, may include logic associated with its port 226a. Accordingly, the port logic can enable a port connected to the DRAG 226a, to perform principal server-side management functions, in concert with the DRAG logic 221, to support dynamic bandwidth allocation disclosed herein. In general a port logic at the servers 225a-225c can allow the ports 226a-226c to: 1) determine the peak bandwidth needed, and issue peak bandwidth requests to the DRAG control logic 221; 2) receive allocated peak bandwidth from the DRAG control logic; 3) limit its operational bandwidth usage to the allocated peak bandwidth granted by the DRAG control logic 221; and 4) detect events that may trigger peak bandwidth allocation adjustments (e.g., fixed time intervals and/or due to events that may be based on switch bandwidth changes, server port bandwidth demand changes, etc.). The port logic for server ports 226a-226c, which can be NIC ports, can be implemented as software, firmware, or hardware or any combination thereof in the server (at the NIC). The port logic of a server, for instance server 225a imparts the capability for the port 226a to detect when the server 225a is trying to send more traffic than the operating maximum bandwidth that is currently set in the NIC's configuration. If this persists, the NIC can communicate a bandwidth request in order to communicate its desired operating maximum bandwidth configuration via a management channel (e.g., out-of-band or in-band). There are several mechanisms that may be used to implement these bandwidth requests from the servers 225a-225c for dynamic bandwidth allocation. In some instances, the bandwidth request, generated based on the port logic's determination, can be communicated to the infrastructure manager 216, which is configured to support the servers 225a-225c to negotiating for adjusted bandwidth allocations. The infrastructure manager 216 can then recalculate the bandwidth distribution among the servers 225a-225c (or NICs) that may be supported on the server-side ports 222a-222c on the DRAG box 222 for DL to the particular server requesting the adjusted bandwidth allocation (e.g., additional bandwidth). Then, the infrastructure manager 216 may adjust the operating maximum bandwidth configuration for the appropriate servers 225a-225c (NICs) and the DRAG box 222 to enable the new distribution of bandwidth allocation. The infrastructure manager 216 may be employed, in some cases, because of increased resources as compared to the DRAG 222. For example, the infrastructure manager 216 may have high computing, memory and storage capabilities compared to DRAG logic 221, especially for fast response time and or relatively high server count per DRAG 222.

In another embodiment, the port logic and associated capabilities for servers 225a-225c using DRAG box 222 can be implemented for each of the NICs for severs 225a-225c to regularly advertise to the infrastructure manager 216, for example, their bandwidth related metrics, such as bandwidth utilization, the statistical average or peak backlog of transmits requests (e.g., indicating that the NIC is not able to send its traffic in a timely manner), and the like. Thus, the infrastructure manager 216 may automatically reconfigure the operating maximum bandwidth for all of the servers 225a-225c and the DRAGS 222 to optimize performance over time. Consequently, as the loads change, the system 200 can dynamically adjust to compensate realizing optimized bandwidth allocations based on the specific traffic demands of the system 200.

In yet another embodiment for implementing port logic and capabilities for servers 225a-225c using DRAG box 222, the NICs may be able to communicate directly with DRAG box 222, for example communicating with a microcontroller implementing the DRAG logic 221. As described above, this communication may be accomplished via in-band management channels. In some cases, the in-band management includes auto-negotiation protocols in accordance with some IEEE standards. Using the in-band channels, NICs in servers 225a-225c can communicate their bandwidth related metrics, such as statistical average bandwidth, sustained peak bandwidths, and traffic backlogs to the DRAG box 222 for example. Then, the DRAG logic 221 can make its own adjustments in the configuration of the DRAG box 222, and subsequently notifies the NICs of these changes, in order for them to in-turn, adjust their operating maximum bandwidth. This approach can be used to implement the DRAG box 222 self-adjusting techniques, as described in reference to the example bandwidth adjustment scenario in FIG. 2A.

Referring now to FIG. 2B, an example of another operation scenario including a DRAG box 222 is shown. The system 280 includes substantially the same structure and elements, such as the switch 210, DRAG box 222, servers 225a-225c as described above in detail with reference to FIG. 2A, and thus are not described again in detail here. However, in this particular illustrated example, the DRAG box 222 includes a switch-side port 221b that is unused, or is not connected to switch 210 or an additional switch that may be co-located within the enclosure 215, for example. This scenario may arise when the ports for DL at the switch 210 are being conserved, which may allow for additional resources, like an additional DRAG box to be connected thereto and expanding the servicing functions of the switch 210. In this case, the aggregated bandwidth provided to the DRAG 220 is only based on the bandwidth at the port 221a that is connected to switch 210. As an example, the switch-side port 221a that is coupled to the port 211a at switch 210 for DL connections may include 2 lanes having 50 G. The aggregate bandwidth of the port 221a at the DRAG is then 100 G, in this example. As a result, each server port 222a-222c can be allowed to have a peak bandwidth that does not exceed 100 G. It is possible for an operational change to occur, which could impact the bandwidth supported by switch 210 towards the DRAG box 222. In instances where these is such as change to system 280, then the DRAG logic 222 would be capable of considering this change to the switch bandwidth, and then adjust the aggregate bandwidth of the switch-side ports accordingly. Another example scenario involving use of the DRAG box 222, where an operational change may affect the bandwidth provided by the switch-side towards the DRAG box 222 is particularly shown in FIG. 2C.

In FIG. 2C, The system 290 includes substantially the same structure and elements, such as the switch 210, DRAG box 222, servers 225a-225c as described in detail above with reference to FIG. 2A, and thus are not described again in detail here. However, in the example of FIG. 2C, the enclosure 215 houses two switches, shown as “switch A” 210 and “switch B” 230. As a result, the DRAG box 222 is connected to the additional switch 230 via its other server-side port 221b. It should be understood that the configuration in FIG. 2C may not be widely utilized in many real-world applications, and often time a DRAG box 220 is typically connected to a single switch. Nonetheless, there are instances where this scenario illustrated in FIG. 2C may occur, and therefore the DRAG box 222 has a functionality that can be applicable in this and similar multiple-switch arrangements. For example, both switch 210 and switch 230 may be employed in the case of a dual DRAG device, housed in a single device/package. In other words, a set of UL connections can be used with one sub-DRAG, and another set of UL connections to another switch. Likewise, a set of DL connections can be used with one sub-DRAG, and another set of DL connections to the other sub-DRAG. Traffic associated with one sub-DRAG may only flow between these DLs and ULs (not between DLs and ULs that belong to different sub-DRAGs). Another scenario wherein the arrangement in FIG. 2C may be used can involve the DRAG box 222 being connected to leaf (or spine) switches. With the use of multiple switches, the bandwidth towards the DRAG box 222 has changed (in comparison to the single switch arrangement in FIG. 2B). In the example, the DRAG logic 222 can take into account that the change in bandwidth provided by multiple switches in its dynamic bandwidth allocation. The DRAG logic 222, as previously described, can perform a handshake via its switch-side ports 221a and 221b in order to determine that a change in the configuration has occurred, namely the addition of switch “B” 230 in this example. The DRAG logic 221 can then consider this change in bandwidth supported by way of the additional switch 230 (due to the configuration change), and ensures that the peak bandwidth for each of the server-side ports 226a-226b does not exceed the aggregate bandwidth of the switch-side port 221a or 221b (coupled the switches 210 and 230 respectively). A concept that is fundamental relating to each of the examples in FIG. 2A-2C is that the DRAG logic 221 is configured to manage the flow through the DRAG box 222 to make ensure that the bandwidth between the UL and DL are balanced, despite the operational and/or topology changes. As a general description, the DRAG logic 221 makes certain that aggregate bandwidth of DL does not exceed the UL. It is possible for the DRAG box 222 to be configured to change DL allocation to sub-DRAGS within the DRAG if sustained performance is deemed to warrant this change; although, typically UL and DL assignments to sub-DRAGS should be changed less frequently as these changes can cause temporary disruption in network traffic flows while address resolution protocols resolve the location of the server ports when moved from one sub-DRAG associated with ULs connected to one switch and another sub-DRAG associated with ULs connected to another switch.

This concept relating to the DRAG logic 221 is also illustrated in FIG. 2D. In this example, some of the servers 225a-225c connected to the DRAG box 222 need varying bandwidth in different time segments. Again, the system 295 in FIG. 2D includes substantially the same structure and elements, such as the switch 210, DRAG box 222, servers 225a-225c as described in detail above with reference to FIG. 2A, and thus are not described in detail here. In particular, the example in FIG. 2D illustrates that the bandwidth allocation for system 295 can be dynamically adjusted by the DRAG logic 221 in a manner that is specifically adapted to the operational conditions for a time segments. The bar graphs 260 and 265 illustrate that the bandwidth allocated for the servers 225a-225c can vary from a first time segment, corresponding to bar graph 260, to a subsequent time segment, corresponding to bar graph 265, showing the temporal aspects of the bandwidth allocation, thereby changing with time (as the bandwidth demands may change).

In this example, there may be four lanes from the switch 210 from port 211a connected to the switch-side port 221a at the DRAG box 222, each supporting a bandwidth of 50 G. Thus, the aggregate bandwidth from the switch 210 to the switch-side port 221a at the DRAG box 222 can be 200 G. Also, the ports 226a-226c at respective servers 225a-225c may have an aggregate peak bandwidth of 400 G. However, the server ports 226a-226c may not be allocated by the DRAG logic 221 to use the peak bandwidth at the current time (e.g., associated with the time segment represented by bar graph 260). As alluded to above, the DRAG logic 221 may periodically handshake with the servers 225a-225c in order to determine the current bandwidth demands for each of the servers 225a-225c in a dynamic manner. In the example, the DRAG logic 221 may perform a handshake at a time segment represented by the bar graph 265. Accordingly, the DRAG logic 221 being aware of the bandwidth utilization and the current bandwidth demands for all of the servers 225a-225c, can adjust the amount of bandwidth allocated to each sever and specific to the operational demands for that time segment.

Referring to the bar graphs 260 and 265, the bar segments corresponding to server “1”, server “2”, server “3”, and server “4” in both graphs 260 and 265 illustrate that the peak bandwidth for these servers, as allocated by the DRAG logic 221, has been modified differently in both time periods. Specifically, the DRAG logic 221 has reduced the bandwidth allocation for server “1” in the time segment of bar graph 265. The DRAG logic 221 has increased the bandwidth allocation for server “2” and server “3” in the time segment of bar graph 265. Lastly, the DRAG logic 221 has reduced the bandwidth allocation for server “4” in the time segment of bar graph 265. Also, as alluded to above, bar graphs 260 and 265 serve to illustrate the reduction of stranded bandwidth that may be realized by the DRAG 220. In the example of FIG. 2D, the DRAG logic 221 has dynamically adjusted the bandwidth allocated for each of the servers 225a-225c in bar graphs 260 and 265, in a manner that ensures that less allocated bandwidth goes unused by the respective server (e.g., less difference between the line segment lengths and the respective bar segment lengths). As illustrated in bar graphs 260 and 265, the line segments “1u”-“16u” are approximately the same length as bar segments “1”-“16”, which conceptually illustrates that substantially little allocated bandwidth is stranded through use of a DRAG box 222.

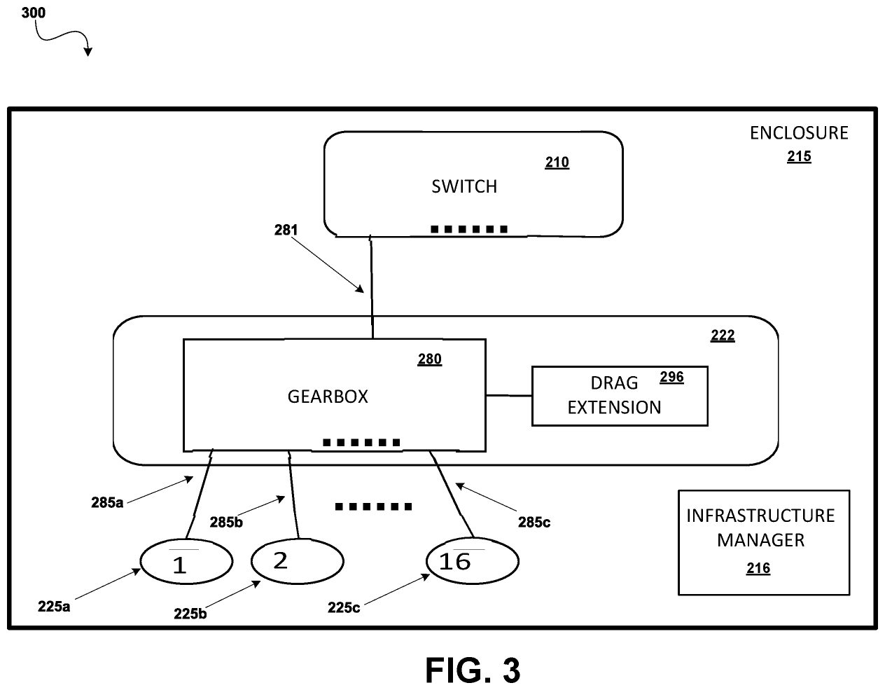

FIG. 3 shows another configuration of an example system 300, in which the DRAG, as disclosed herein can be implemented as an extension, or otherwise retrofitted, to a traditional gearbox 280. In FIG. 3, the system 300 utilizes a traditional gearbox 280, which is shown as being directly coupled to a DRAG extension 296. The DRAG extension 296 may be implemented as software, firmware, hardware, circuitry, or any combination thereof deemed suitable to implement the DRAG capabilities in accordance with the embodiments. For instance, in some embodiments, the DRAG extension 296 can be a device including an integrated chip (IC) circuit programmed to perform the DRAG capabilities as disclosed, such as an application-specific integrated circuit (ASIC).

The DRAG extension 296 can have an interface with the gearbox 280 that facilitates communicate and control of the gearbox 280 and its functions, allowing the otherwise traditional gearbox 280 to function in a manner similar to the DRAG box (having the DRAG logic integrated there, as described in refiner to FIG. 2A, for example), realizing optimized bandwidth utilization. FIG. 3 also illustrated the traditional gearbox 280 and the DRAG extension 296 can be housed in the same structure, or box 222, such as a 1 U box. Thus, the box 222 including the DRAG extension 296 may be easily placed in a rack.

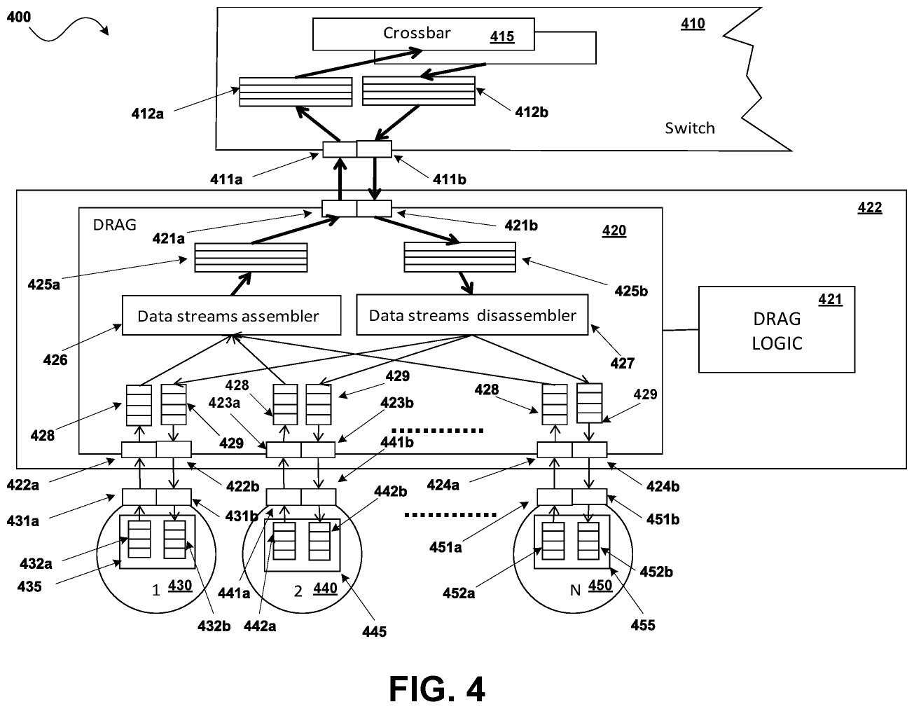

FIG. 4 depicts another example of a switch system 400 including the DRAG 420, as disclosed herein. Again, the system 400 in FIG. 4 includes substantially the same structure and elements, such as the switch 410, DRAG box 422, servers 430, 440, and 450 as described in detail above with reference to FIG. 2A, and thus are not described in detail here. In the example, data buffers and an example data path within the system 400 are shown, which can be used to implement the disclosed bandwidth negotiation techniques described above. For example, the switch 410 is shown to include: crossbar 415; switch downlink receive (SW-DL-RX) buffer 412a; switch downlink transmit (SW-DL-TX) buffer 412b; and switch downlink ports 411a, 411b. The DRAG box 422 is shown to include: the DRAG uplink transmit (DRAG-UL-TX) buffer 425a; DRAG uplink receive (DRAG-UL-RX) buffer 425b; data stream assembler 426; data stream disassembler 427; DRAG downlink receive (DRAG-DL-TX) buffers 428; DRAG downlink transmit (DRAG-DL-RX) buffers 429; and DRAG downlink ports 422a, 422b, 423a, 423b, 424a, and 424b. Furthermore, each of the servers 430, 440, and 450 are shown to include respective NIC buffers. In detail, server 430 includes: ports 431a, 431b; NIC transmit buffer (NIC-TX) buffer 432a; NIC receive (NIC-RX) buffer 432b; and NIC 435. Server 440 includes: ports 441a, 441b; NIC transmit buffer (NIC-TX) buffer 442a; NIC receive (NIC-RX) buffer 442b; and NIC 445. The configuration will be typically similar for each server that may be coupled to the DRAG 420, each including respective TX and RX buffers, and so on for each server, until an “N” server 450. Server 450 is shown to include: ports 451a, 451b; NIC transmit buffer (NIC-TX) buffer 452a; NIC receive (NIC-RX) buffer 452b; and NIC 455. As alluded to above, the DRAG logic 421 dynamically manages the bandwidth allocation to the server ports 431a, 431b, 441a, 441b, 451a, 451b to enable peak bandwidth for the servers 430, 440, and 450, while ensuring that the maximum bandwidth utilization of the DRAG UL port 421a does not exceed the switch DL 411a to prevent data losses.

As illustrated in FIG. 4, each of the DRAG DL ports 422a, 422b, 423a, 423b, 424a, and 424b is connected to a DRAG-DL-RX buffer 428 and a DRAG-DL-TX 429 buffer, in order to store bidirectional data streams to and/or from the corresponding server port. Also, each DRAG UL port 421a, 421b is connected to a DRAG-UL-TX 425a and DRAG-UL-RX 425b buffer, in order to store bidirectional data streams to and/or from the corresponding switch DL ports 411a, 411b. Data streams from each of the DRAG-DL-RX buffers 428 flow to a DRAG-UL-TX buffer 425a though the data streams assembler 426. At the data streams assembler 426, the data from data streams is collated from the plurality of DRAG-DL-RX buffers 428, and the data stream headers encoded. Then, the data streams assembler 426 can transmit the collated data streams as one concatenated data stream to a DRAG-UL-TX buffer 425a. The data stream headers may correspond to an identifier for a particular DRAG-DL-RX buffer 428, which in turn, is associated to an identifier for a respective server 430, 440, 450 that connects to a particular DRAG DL port 422a, 422b, 423a, 423b, 424a, 424b. For example, “ID-1” may correspond to a server 430, “ID-2” for server 440, and so on.

Data streams from a DRAG-UL-RX buffer 425b can flow to a designated one of the DRAG-DL-TX buffers 429 through the data streams disassembler 427. At the data stream disassembler 427, the data streams from the DRAG-UL-RX buffer 425b can be separated to a plurality of data streams for the corresponding DRAG-DL-TX buffer 429 (e.g., according to the decoded data stream headers). Additionally, the DRAG logic 421 can set a high watermark for each DRAG-DL-RX buffer 428 in order to regulate the data flow from each of the server port 431a, 431b, 441a, 441b, 451a, 451b. In some cases, the high water mark may initially be set equally among all of the DRAG-DL-RX buffers 428, where the corresponding server ports 431a, 431b, 441a, 441b, 451a, 451b are active.

Each server port, shown as 431a, 441a, and 451a, may send data streams to a corresponding DRAG DL port 422a, 423a, 424a. In some situations, data streams are sent to a DRAG-DL-RX buffer 428 with utilization lower than the high watermark. When the DRAG-DL-RX buffer 428 utilization reaches the watermark, the DRAG logic 421 may send a PAUSE frame to the respective server port (via the DRAG-DL-TX buffer 429 with a priority) so that the PAUSE frame will be transmitted bypassing queued data streams in the DRAG-DL-TX buffer 429. Server NIC, e.g., 435, receiving a PAUSE frame will stop transmitting data to DRAG receive port, e.g., 422a.

In some examples, data streams disassembler may replicate data from DRAG-RX buffer 425b onto multiple DRAG-DL-TX buffers to multicast a data stream. For example, data streams may be replicated to DRAG-DL-TX buffers corresponding to all servers, except to Server 430, where Server 430 receive port 431b will be allocated 50% of the switch downlink TX bandwidth and all the other servers will have the other 50% where data stream is replicated to Server 440, 450 and so on. In other examples, all DRAG-DL-TX buffers 429 can broadcast a data stream at full data rate of server receive ports 431b, 441b and 424b.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An apparatus, comprising:
a plurality of server interface ports, wherein each of the plurality of server interface ports is for coupling to a respective server and corresponds to a provisioned bandwidth for each of the severs;
at least one switch interface port, wherein the at least one switch interface port is for coupling to at least one respective switch and corresponds to a provided bandwidth from the switch; and
circuitry for dynamically adjusting an allocation of the provisioned bandwidth for each of the plurality of server interface ports within a time period, wherein the circuitry programs the apparatus to:
dynamically determine an aggregated provided bandwidth from the at least one switch interface port based on a sum of the provided bandwidth from the at least one switch coupled to the at least one interface port at the time period;
for each of the plurality of server interface ports, dynamically allocate an amount of provisioned bandwidth for use by the respective server that is coupled to the server interface port, wherein the amount of provisioned bandwidth is allocated such that an aggregation of the amount of provisioned bandwidth allocated to the plurality of servers interface ports within the time period does not exceed the provided bandwidth from the at least one switch interface port associated with the time period; and
provide the amount of provisioned bandwidth as dynamically allocated for each of the plurality of server interface ports for use by each respective server.

2. The apparatus of claim 1, wherein each of the server interface ports is coupled to a respective server via a link, and the link is coupled to a respective server port at the respective server.

3. The apparatus of claim 1, wherein the at least switch interface port is coupled to a respective switch via a link, and the link is coupled to a respective downlink (DL) port at the respective switch.

4. The apparatus of claim 1, wherein the amount of provisioned bandwidth is based on aggregated provided bandwidth from the at least one switch interface port evenly-divided between each of the plurality of server interface ports.

5. The apparatus of claim 1, wherein the amount of provisioned bandwidth is an initial allocation for each the plurality of server interface ports.

6. The apparatus of claim 5, wherein the circuitry further programs the apparatus to:
for each of the plurality of server interface ports, dynamically determine an amount of bandwidth utilized in operation by the plurality of server interface port associated with a time period.

7. The apparatus of claim 6, wherein the circuitry further programs the apparatus to:
for each of the plurality of server interface ports, dynamically determine an amount of bandwidth requested by the respective server coupled to the server interface port associated with a time period.

8. The apparatus of claim 7, wherein the circuitry further programs the apparatus to:
for each of the plurality of server interface ports, dynamically adjust the initial allocation to an amount of provisioned bandwidth based on the amount of bandwidth utilized in operation or the amount of bandwidth requested by the respective server.

9. The apparatus of claim 1, wherein circuitry comprises a microcontroller.

10. The apparatus of claim 1, wherein the circuitry further programs the apparatus to:
for each of the plurality of server interface ports, perform a bandwidth negotiation with a server port at the respective server coupled to the server interface ports.

11. The apparatus of claim 10, wherein the bandwidth negotiation is performed in-band using auto-negation or out-of-band using an infrastructure manager.

12. The apparatus of claim 1, wherein each of the plurality of server interface ports have a bandwidth capability that is equal to a bandwidth capability of the switch interface port in a manner that allows each of the server interface ports to fully utilize the bandwidth of the switch interface port.

13. The apparatus of claim 1, wherein the circuitry further programs the apparatus to:
perform data replication from the at least one switch interface port to each of the plurality of server interface ports in a manner that transfers the same data from the switch interface port to each of the plurality of server interface ports.

14. The apparatus of claim 1, wherein the circuitry is comprised within an extension hardware.

15. The apparatus of claim 14, wherein the plurality of server interface ports and the at least one server interface port is comprised within a gearbox hardware that is separate from the extension hardware.

16. The apparatus of claim 15, wherein the gearbox hardware is a standard gearbox.

17. A dynamic ratio adjusting gearbox (DRAG) comprising:
a sub-gearbox, wherein the sub-gearbox comprises:
a plurality of server interface ports, wherein each of the plurality of server interface ports is for coupling to a respective server and corresponds to a provisioned bandwidth for each of the severs; and
at least one switch interface port, wherein the at least one switch interface port is for coupling to at least one respective switch and corresponds to a provided bandwidth from the switch; and
gearbox logic coupled to the sub-gearbox, wherein the gearbox logic comprises:
circuitry for dynamically adjusting an allocation of the provisioned bandwidth for each of the plurality of server interface ports within a time period, wherein the circuitry programs the DRAG to:
dynamically determine an aggregated provided bandwidth from the at least one switch interface port based on a sum of the provided bandwidth from the at least one switch coupled to the at least one interface port at the time period;
for each of the plurality of server interface ports, dynamically allocate an amount of provisioned bandwidth for use by the respective server that is coupled to the server interface port, wherein the amount of provisioned bandwidth is allocated such that an aggregation of the amount of provisioned bandwidth allocated to the plurality of servers interface ports within the time period does not exceed the provided bandwidth from the at least one switch interface port associated with the time period; and
provide the amount of provisioned bandwidth as dynamically allocated for each of the plurality of server interface ports for use by each respective server.

18. The DRAG of claim 17, further comprising:
an additional sub-gearbox coupled to the gearbox logic, wherein the gearbox logic further programs the dynamic to:
dynamically adjust downlink allocation to the sub-gearbox and the additional sub-gearbox within the DRAG.
